(19) United States
(12) Patent Application Publication
(10) Pub. No.: US 2019/0303035 A1
(43) Pub. Date: Oct. 3, 2019

(54) COPYING GARBAGE COLLECTOR FOR GEOGRAPHICALLY DISTRIBUTED DATA STORAGE ENVIRONMENT

(71) Applicant: EMC IP Holding Company LLC, Hopkinton, MA (US)

(72) Inventors: Mikhail Danilov, Saint Petersburg (RU); Irina Tavantseva, Saint Petersburg (RU)

(21) Appl. No.: 15/936,912

(22) Filed: Mar. 27, 2018

(51) Int. Cl. G06F 3/06

(52) U.S. Cl. CPC G06F 3/0652; G06F 3/067; G06F 3/065; G06F 3/0604

(57) ABSTRACT

The described technology is generally directed towards a copying garbage collector in a geographically distributed data storage system that processes low data capacity usage chunks into combined (new, real) chunks with relatively high data capacity utilization. Low capacity utilization chunks are detected, with two or more selected as source chunks. A virtual chunk comprising data layout metadata is created to correspond to the selected source chunks' data. The virtual chunk is replicated to other geographic zones. The data from the source chunks are read into the virtual chunk, which becomes a higher capacity utilization combined chunk. This occurs independently in each zone, e.g., replica source chunks are read into the replica virtual chunk that was replicated to a remote zone. In each zone, once the data is read into the virtual chunk, the virtual chunk is encoded into a real chunk, and the source (low-capacity usage) chunks are deleted.

### TECHNICAL FIELD

The subject application relates generally to data storage, and, for example, to a copying garbage collector that creates data chunks from the data of other chunks and replicates the created data chunks in a geographically distributed environment, and related embodiments.

### BACKGROUND

Contemporary cloud-based storage systems, such as Dell EMC® Elastic Cloud Storage (ECS™) service, store data in a way that ensures data protection while retaining storage efficiency. One commonly practiced maintenance service related to storage efficiency is garbage collection, which reclaims storage space that was formerly used for storing user data, but is no longer in use. For example, when storage clients delete data, the deletion operations cause sections of dead capacity in the storage system, which in general remain until the capacity can be reclaimed via garbage collection.

In ECS™, user data are stored in chunks. As part of its operations, a garbage collector reclaims space from old chunks that have poorly used (low percentage usage) capacity. However, moving data such as from old chunks into new chunks consumes significant resources, in part due to data protection schemes such as used in ECS™. Resource consumption becomes even more significant in geographically distributed environments in which data is replicated to geographically distributed zones.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, one or more aspects of the technology described herein are directed towards detecting low capacity utilization chunks among data storage system chunks, wherein low capacity is determined according to a defined criterion, and creating a virtual chunk. Aspects can comprise reading corresponding data from a plurality of low capacity utilization chunks into the virtual chunk, encoding the virtual chunk to create a combined chunk in the data storage system and deleting the low capacity utilization chunks.

Other embodiments may become apparent from the following detailed description when taken in conjunction with the drawings.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of part of a cloud data storage system including nodes, in which a copying garbage collector processes low data usage capacity chunks into combined chunks, according to one or more example implementations.

FIG. 2 is an example block diagram/data operation diagram representation of copying garbage collection, according to one or more example implementations.

FIGS. 3-7 are representations of an example of copying garbage collection that uses a virtual chunk and a replica virtual chunk in geographic zones to process low data utilization capacity chunks into combined chunks, according to one or more example implementations.

FIG. 8 is a flow diagram representing example operations for locating low capacity utilization data chunks for garbage collection %, according to one or more example implementations.

FIG. 9 is a flow diagram representing example operations for performing copying garbage collection, including in a primary (local) and other (remote) geographic zone, according to one or more example implementations.

FIG. 10 is an example flow diagram showing example operations related to copying garbage collection, according to one or more example implementations.

FIG. 11 is an example block diagram showing example logic components of a copying garbage collector and data chunk manager, according to one or more example implementations.

FIG. 12 is an example flow diagram showing example operations related to garbage copying collection, according to one or more example implementations.

FIG. 13 is a block diagram representing an example computing environment into which aspects of the subject matter described herein may be incorporated.

### DETAILED DESCRIPTION

Various aspects of the technology described herein are generally directed towards garbage collection in cloud-based storage systems, such as Dell EMC® Elastic Cloud Storage (ECS™) service. In general, and as will be understood, the technology copies data from low capacity utilization chunks into new chunks in a way that avoids the need for preliminary protection schemes, while still maintaining data protection. The old low capacity utilization chunks are safely deleted so as to reclaim their storage space.

In one or more aspects, the technology uses only relatively small amounts of inter-zone network traffic for replicating the data in a geographically distributed environment having geographically distributed data storage zones. To this end, the technology inter-zone replicates only the metadata (e.g., via a virtual chunk) to one or more other geographically distributed zones, and each other zone then performs intra-zone garbage collection based on the virtual chunk. No user data need be transferred over the inter-zone network communications link.

In one or more aspects, the copying garbage collection technology generally leverages the concept of pull migration, in which a migration destination storage pulls data objects from a source storage. Because the data to migrate is already protected by the source storage, pull migration can handle the data being migrated without needing any preliminary protection schemes.

Unlike the original pull migration technology, however, rather than pull user data objects, one or more implementations of the copying garbage collection technology described herein, the technology pulls segments of old chunks that are still in use. Note that chunks can be shared, in that one chunk may contain segments of multiple user objects; e.g., the storage space allocated to one chunk can contain mixed segments of a number of different user objects. In copying garbage collection as described herein, the technology allows newly created chunks to pull data segments from old, poorly used chunks. This provides a kind of internal pull migration, in which a data migration source is a set of one or more old chunks and a data migration target is a set of one or more new chunks. Notwithstanding, the pulling of data segments is only one technique exemplified herein, and the technology is not limited to copying segments, nor to pulling the data.

In one or more aspects, a garbage collector uses information about inefficiently used (low capacity utilization) chunks to compose a set of still-used segments that will populate a new chunk or new chunks. Once the set of low capacity utilization segments and associated chunks is identified, the garbage collector creates a new chunk. Note that at this time, no physical capacity is allocated for the new chunk; however, the garbage collector creates a data layout within the new chunk, and thus the new chunk is referred to herein as a “virtual” chunk, (in contrast to the new real chunk that ultimately will have the physical capacity allocated for the copied data).

Once the virtual chunk is created, replication technology (e.g., automatic in ECS™) replicates the virtual chunk, which is pure system metadata, to remote geographic zone(s). Because only the virtual chunk metadata is being replicated across geographic zones, the replication operation is very efficient, having relatively low network traffic. Note that the still-used segments are already in replicas of the chunks in each other zone.

At each zone, encoding is requested for the new chunk. In an associated operation, a part of the storage service responsible for erasure coding (e.g., a chunk manager) reads the chunk into a fast (e.g., volatile) memory. Because the new chunk is virtual, the read requests for data segments are automatically redirected to the old chunks, that is, any read request to the new chunk pulls data segment(s) from the old chunks. The storage service performs encoding of the chunk in the volatile memory, and when the chunk is ready, stores the combined chunk data and the combined chunk's associated coding fragments in non-volatile storage devices as a new, real combined chunk.

Once the combined chunk is stored as a new, real chunk in the non-volatile storage devices, the garbage collector deletes the old source (the low utilization capacity) chunks. The data of the old source chunks were fully offloaded during the encoding iteration.

Note that the data remains protected even though no preliminary protection scheme is used, in that new chunks are protected directly using erasure coding. The old chunks, which are previously protected, are not deleted until the new chunk is successfully saved in the non-volatile storage devices (as chunk data and the chunk's associated coding fragments). Thus, the data remains protected throughout the garbage collection process.

It should be noted that the operations following replication of the virtual chunk can be performed by each other zone in parallel (or otherwise whenever appropriate for a zone to do so). Each replicated zone uses its own zone's replicas of old chunks to fill the new chunk(s), based on the replicated new virtual chunk's metadata. The availability of such replicated copies is already virtually guaranteed for two-zone setups and for setups with (an already existing in ECS™) “replicate to all zones” feature enabled. Note that copies also can be available in other cases. For instance, each chunk has a primary zone, with copies replicated to other zone(s). A copy of an old chunk may reside in a zone-local geographic replication cache; in such a situation, a request to read data from an unavailable copy of an old chunk is directed to the chunk's primary zone.

It should be understood that any of the examples herein are non-limiting. For instance, some of the examples are based on ECS™ cloud storage technology; however virtually any storage system may benefit from the technology described herein. Thus, any of the embodiments, aspects, concepts, structures, functionalities or examples described herein are non-limiting, and the technology may be used in various ways that provide benefits and advantages in computing and data storage in general.

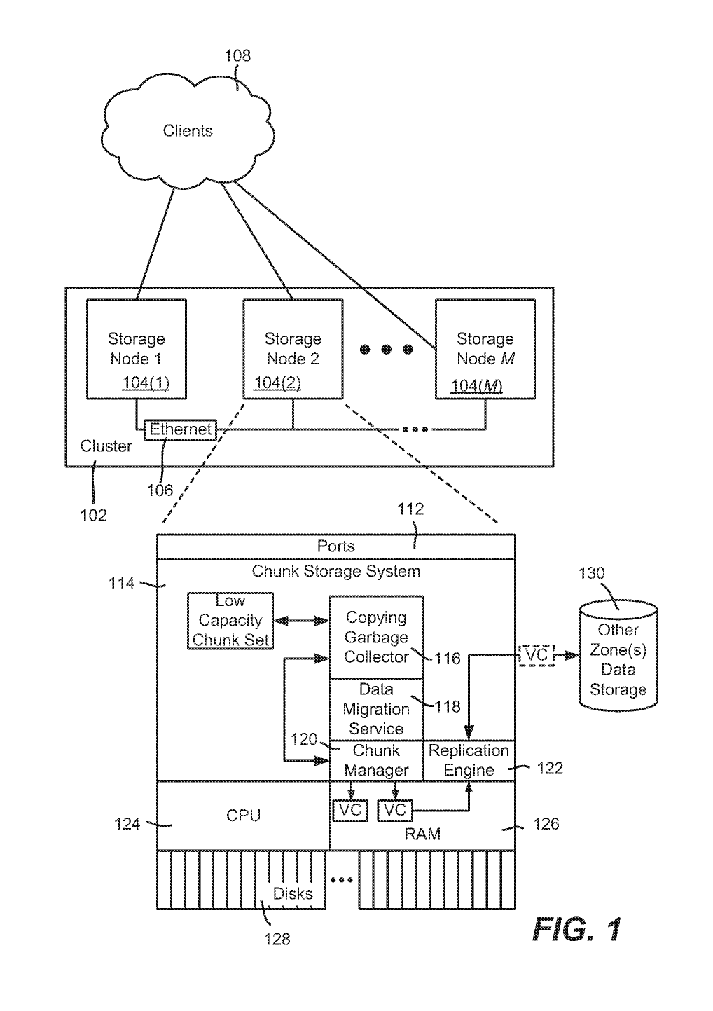

FIG. 1 shows part of a cloud data storage system such as ECS™ comprising a zone (e.g., cluster) 102 of storage nodes 104(1)-104(M), in which each node is typically a server configured primarily to serve objects in response to client requests. The nodes 104(1)-104(M) are coupled to each other via a suitable data communications link comprising interfaces and protocols, such as represented in FIG. 1 by Ethernet block 106.

Clients 108 make data system-related requests to the cluster 102, which in general is configured as one large object namespace; there may be on the order of billions of objects maintained in a cluster, for example. To this end, a node such as the node 104(2) generally comprises ports 112 by which clients connect to the cloud storage system. Example ports are provided for requests via various protocols, including but not limited to SMB (server message block), FTP (file transfer protocol), HTTP/HTTPS (hypertext transfer protocol) and NFS (Network File System); further, SSH (secure shell) allows administration-related requests, for example.

Each node, such as the node 104(2), includes an instance of a chunk storage system 114 and data services, which can include a copying garbage collector 116, data migration service (logic) 118, a chunk manager 120 and a replication engine 122. Note that at least some of these components can be per-cluster, rather than per-node. A CPU 124 and RAM 126 are shown for completeness; note that the RAM 126 may comprise at least some non-volatile RAM. The node includes storage devices such as disks 128, comprising hard disk drives and/or solid-state drives.

In general, and in one or more implementations, e.g., ECS™, disk space is partitioned into a set of large blocks of fixed size called chunks; user data is stored in chunks. Chunks are shared, that is, one chunk may contain segments of multiple user objects; e.g., one chunk may contain mixed segments of some number of (e.g., three) user objects. This approach assures high write performance and capacity efficiency when storage clients write data only. However, when storage clients delete data, the deletions cause sections of dead capacity within chunks. As a result, capacity efficiency becomes an issue.

As also represented in FIG. 1, the replication engine 122 replicates data to other (“remote”) zone(s) 130. As will be understood, virtual chunks (VCs), e.g., in RAM 126, can be replicated to the other zone(s) 130 as described herein. The concept of “virtual” chunks bypasses the relatively heavyweight handling of newly data that result from preliminary data protection schemes. Note that no significant physical capacity is allocated for these virtual chunks, however virtual chunks do contain metadata comprising a data layout corresponding to actual data in chunks that consume physical capacity.

Encoding of a virtual chunk works as the part of the storage service responsible for erasure coding (e.g., the chunk manager 120) reads the virtual chunk into a volatile memory, e.g., as an instance in the RAM 126. Because the new chunk is virtual, read requests to that virtual chunk are redirected (e.g., via the data migration service 118) to the source storage, that is, the destination storage (the virtual chunk in non-volatile memory) pulls data from the source storage, which as will be understood comprise the chunks identified as low utilization capacity chunks. The chunk manager 120 performs encoding of the chunk in a volatile memory and when the chunk is ready, stores data and coding fragments as a non-volatile, protected chunk to cluster nodes/disks. Note that the direct erasure coding avoids the use of preliminary protection schemes, which dramatically increases the efficiency of the overall process.

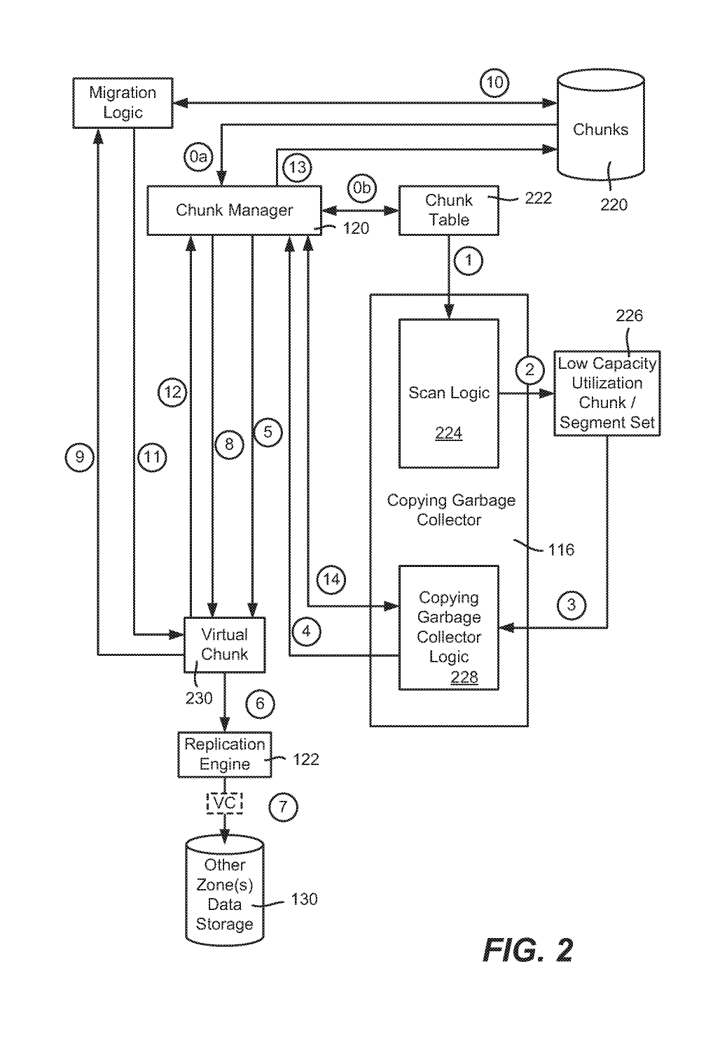

As represented in FIG. 2, in an example implementation the copying garbage collector 116 detects chunks with low capacity utilization. For example, as represented by arrows 0a and 0b, as part of managing a zone's chunk data 220, the chunk manager 120 regularly maintains a chunk data structure (e.g., a chunk table 222 persisted to a non-volatile memory); in one or more implementations, scan logic 224 incorporated into (or coupled to) the copying garbage collector 116 performs periodic (or otherwise scheduled) scanning of the chunk table 222 as represented in FIG. 2 via the arrow labeled (1). Scanning finds low capacity utilization chunks, represented by block 226.

Capacity utilization may be calculated as the ratio of used chunk capacity to total chunk capacity. A chunk is considered to have low (lower) capacity utilization when the chunk has capacity utilization below some predefined threshold. What is considered inefficient with respect to chunk usage can be determined via a configurable threshold value, which is determined as a tradeoff between capacity use efficiency and additional workload produced by the copying garbage collector. For example, a chunk having still-used segments totaling less than fifty percent of the chunk's total space may be considered an inefficient chunk usage in one garbage collection scenario, (while a more aggressive garbage collection scenario may use higher still-used percentage, and so on). The threshold can vary, such as to be more aggressive as available space becomes scarcer, or become less aggressive when the storage system is otherwise very busy, and so on. To throttle garbage collection workload, the set need not be the entire set of low capacity utilization chunks in the zone, but instead can be some subset of those collected within some limiting criterion, such as based on a time limit, a size limit, a count or percentage, and so on. The limiting criterion can vary, e.g., collect many low capacity utilization chunks per garbage collection iteration when the data service is otherwise not busy, such as during the weekend, but collect a smaller number when otherwise busy. Garbage collection can be repeated in a next iteration, such as periodically, to reclaim space of low capacity utilization chunks missed in the previous garbage collection iteration, as well as any chunks that have become low capacity utilization chunks since the last garbage collection iteration.

As further represented in FIG. 2, copying garbage collection logic 228 of the copying garbage collector 116 accesses the low capacity utilization chunk/segment set 226 (arrow (3)) to create virtual chunks for the segments from the low capacity utilization chunks. For any given virtual chunk, the segments to be copied can be selected based on their sizes (and possibly based on the object to which they belong) so as to efficiently load the new chunk, for example. As part of creation, the copying garbage collection logic 228 establishes the data layout of the virtual chunk, e.g., generates the metadata indicating the source locations of the actual underlying data segments in a low capacity utilization chunk (or chunks), their offsets in the new chunk, and so on.

The operations continue, e.g., for each new virtual chunk, until the set of low capacity utilization chunks has been handled; (for purposes of explanation, the technology will be described with reference to one new virtual chunk 230 being created and handled at a time, although it is understood that many of these operations can be performed in parallel, including having multiple virtual chunks created and processed generally together). To create a new virtual chunk, the chunk manager 120 can be invoked (arrows (4) and (5)), although it is alternatively feasible for the copying garbage collection logic 228 to create the virtual chunk and notify other entities, such as the chunk manager, of its creation.

As represented by arrows (6) and (7), the replication engine 122 replicates the virtual chunk to the other geographic zone or zones 130. In ECS™, such replication can be automatic, however it is alternatively straightforward to send a notification or the like to trigger replication, e.g., in other data storage environments.

Encoding is requested for the new virtual chunk 230, which can be part of the request to the chunk manager 120 to create the new virtual chunk (arrow (4)), or a separate request from the copying garbage collection logic 228. In any event, in response to the encoding request, in one implementation the chunk manager 120, which is responsible for erasure coding, reads the chunk into a volatile memory (or for example accesses the chunk if already in a volatile memory), including making read requests (arrow (8)). Because the new chunk is virtual, the read requests are redirected to the old chunks within the actual set of chunk data 220, that is, the new chunk pulls data from the old chunks, as represented in FIG. 2 via arrows (9), (10) and (11). Note that the operations represented by arrows (8) though (11) can be repeated (possibly in parallel to an extent) until the virtual chunk 230 has the full set of segments read into the virtual chunk 230.

When the virtual chunk contains the data read/pulled from the sources (low capacity utilization chunks), the chunk manager 210 performs the encoding of the chunk (in volatile memory), and stores (arrow (13)) the corresponding data and coding fragments in one or more storage devices, e.g., within the cluster's disks 128, represented as the chunk data 220.

Once the new chunk (data and coding fragments) is safely written to and protected in non-volatile storage, as represented by arrow (14), the copying garbage collector 116 operates to delete the low capacity utilization source chunks, which were fully offloaded during the above-described iteration, and thereby reclaim their capacity. Any virtual chunk data/references may be cleaned up from memory, tables, etc.

As is understood, the operations corresponding to arrows (8) and above are performed independently at each other geographic zone. That is, once an instance of the virtual chunk 230 is replicated to another zone, the other zone uses its own components to read its own zone's low capacity utilization chunk replicas that contain the data into the virtual chunk replica, encode the (now filled with zone—local reads) virtual chunk replica into non-volatile storage and delete the zone's own low capacity utilization chunk replicas. In the event that the low capacity utilization chunk replicas have not been yet replicated to the other zone, the replication technology in ECS™ automatically operates to retrieve the chunk data from a replication cache of the primary zone that “owns” the chunk.

Note that in an ECS™ implementation, the above-described technology can leverage components that already exist. For example, replication and the concept of virtual chunks (e.g., otherwise implemented for pull migration support) are existing components in contemporary ECS™ systems. Notwithstanding, replication of virtual chunk metadata and redirecting reads can be implemented on other data storage systems to achieve the technology described herein.

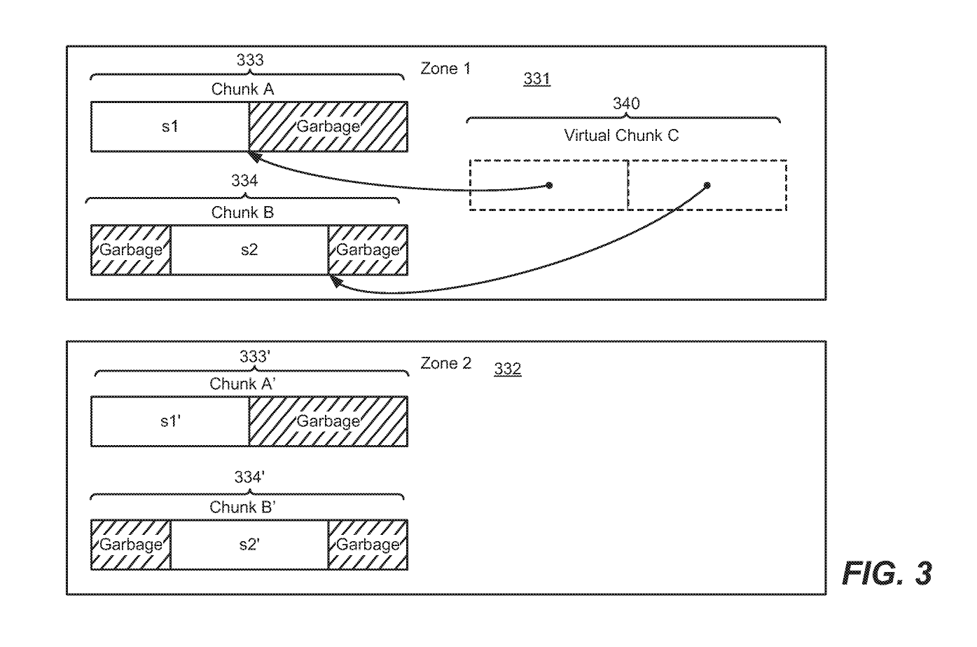

Turning to the examples of FIGS. 3-7, consider that in FIG. 3, a first geographic zone 1 (labeled 331) contains chunk A (labeled 333) and chunk B (labeled 334). A second geographic zone 2 (labeled 332) contains backup replicas of these chunks, chunk A′ (labeled 333′) and chunk B′ (labeled 334′). Real chunk A (333) contains only one segment, s1, which occupies only half the capacity of the real chunk A (333), with the remaining half of the chunk content being garbage. Therefore, the real chunk A (333) has low capacity utilization, assuming that the threshold value is such that fifty percent actual usage is considered low usage capacity. In this simplified example, real chunk B (334) contains only one segment, s2, which occupies only half the capacity of the real chunk B (334), with the remaining half of the chunk content being garbage. Therefore, the real chunk B (334) also has low capacity utilization, assuming the same threshold. Note that in this simplified example two source chunks are combined, however it is understood that more than two source chunks can be combined, and further, that a more complex combining operation can take place, e.g., combine four low capacity usage chunks into three higher capacity usage chunks in a single iteration, and so on.

As a result, the copying garbage collector (at Zone 1 331) selects these chunks for processing. As part of this processing, the garbage collector creates a virtual chunk, chunk C (labeled 340), to accommodate the two used sections, s1 of Chunk A (333) and s2 of Chunk B (334), as represented by the curved arrows.

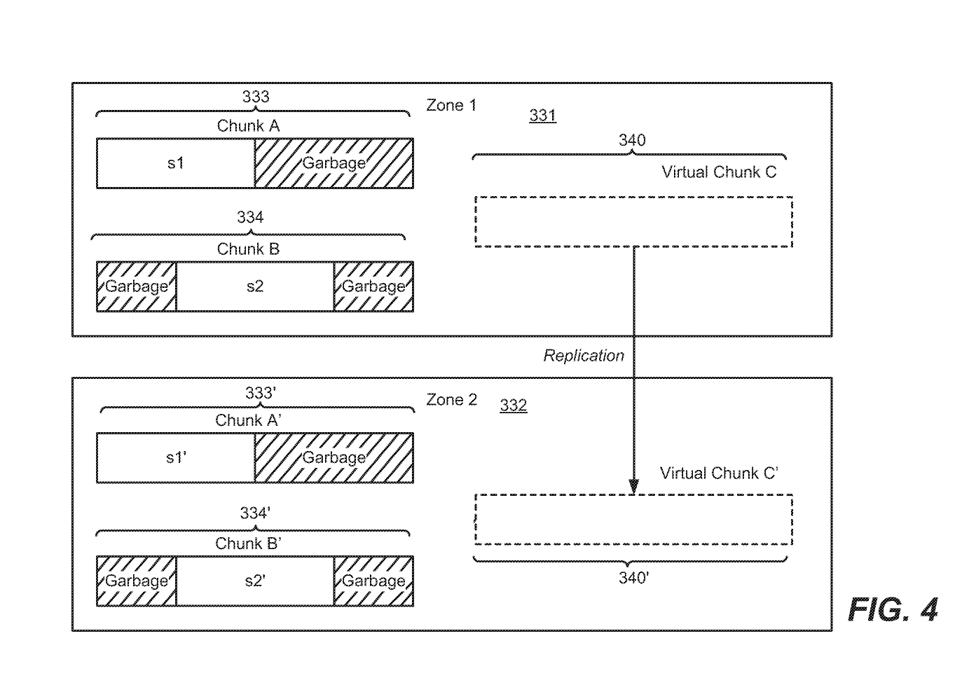

As represented in FIG. 4, information about the new virtual chunk C (340), the virtual chunk (e.g., including layout) metadata, gets replicated to Zone 2 (332). In turn, the garbage collection-related components of Zone 2 (332) including the replication component(s) create a new virtual chunk C′ (labeled 340′).

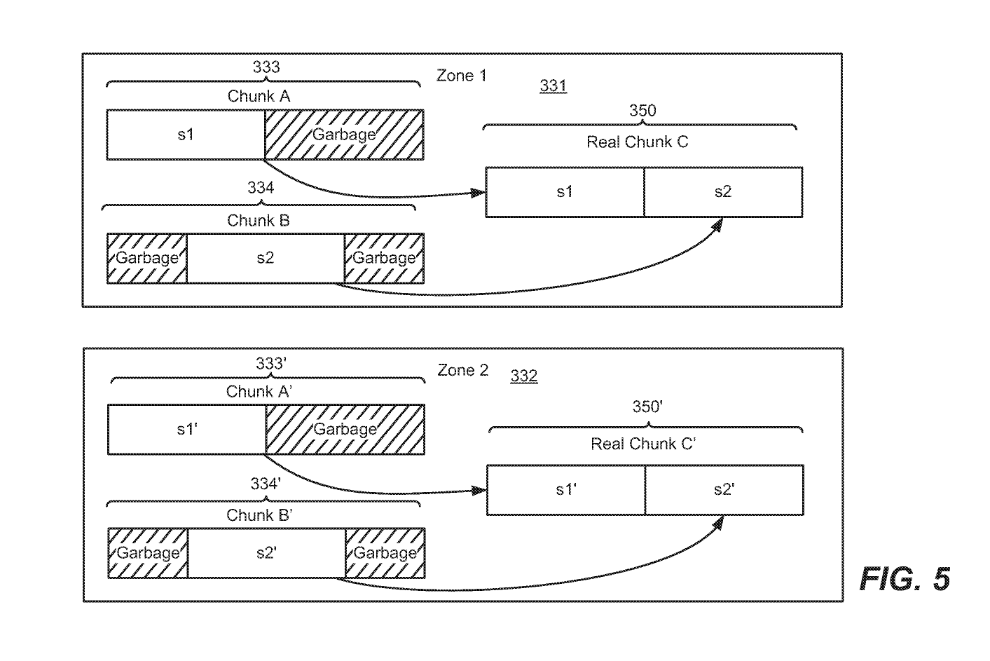

As represented in FIG. 5, the metadata of the virtual chunk C (340, FIG. 4) is used by the garbage collection-related components of zone 1 (331) to pull data segment s1 from the source chunk A (333) and data segment s2 from the source chunk B (334) into a new real chunk C (labeled 350) in zone 1 (331). Similarly, but independently, the metadata of the replicated virtual chunk C′ (340′, FIG. 4) is used by the garbage collection-related components of zone 2 (332) to pull data segment s1′ from the replica source chunk A′ (333′) and data segment s2′ from the replica source chunk B′ (334′) into a new real chunk C′ (labeled 350′).

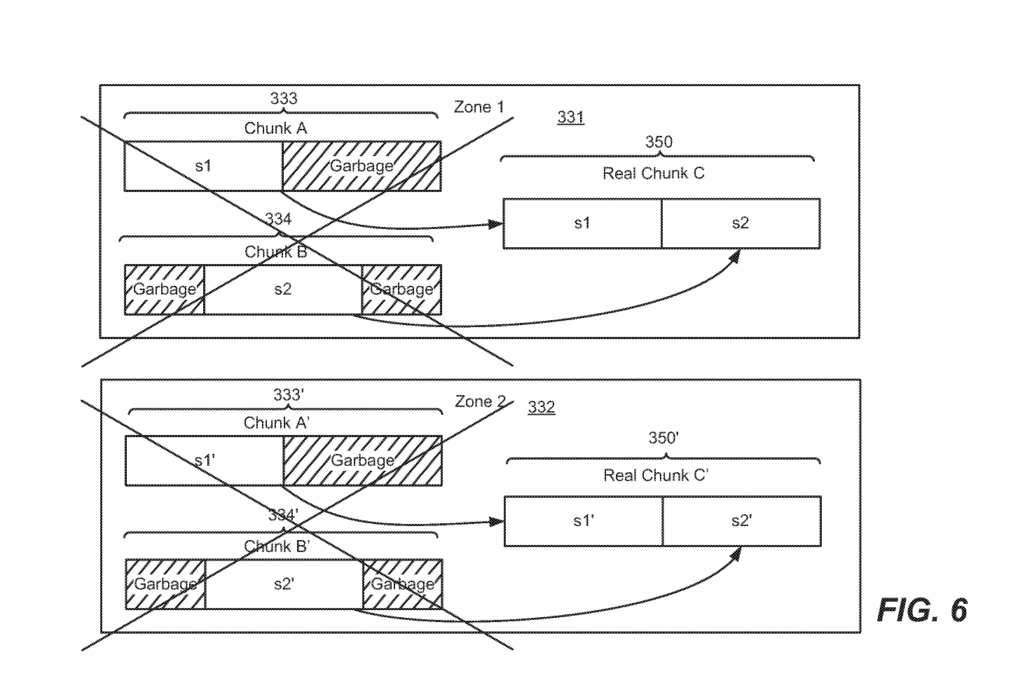

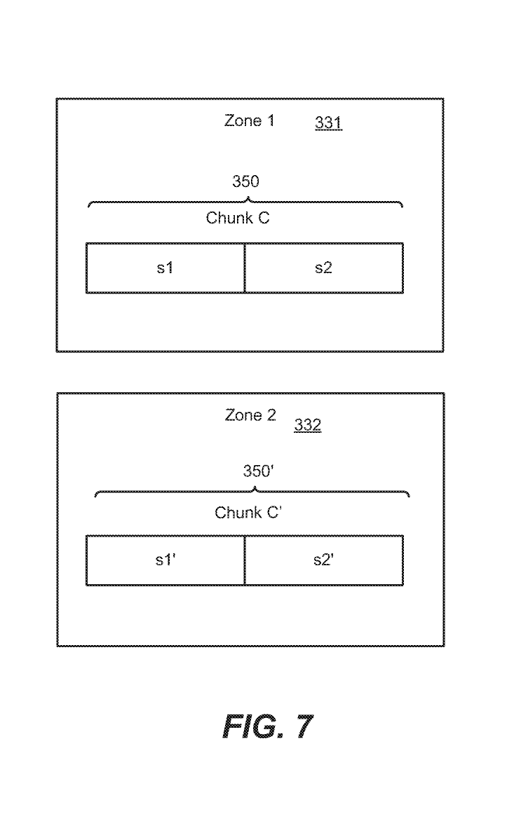

As represented in FIG. 6, once saved to storage, the garbage collector in each zone independently deletes (as represented by the “X-ing” out of the chunks) the chunks with low capacity utilization, that is, zone 1 (331) deletes chunk A (333) and chunk B (334), and separately zone 2 (332) deletes chunk A′ (333′) and chunk B′ (334′). The space in each zone occupied by these chunks is thus able to be reclaimed, resulting in the chunks 350 and 350′ represented in FIG. 7, which consume less space than the chunks 333, 334, 333′ and 334′ as originally in use in FIG. 3.

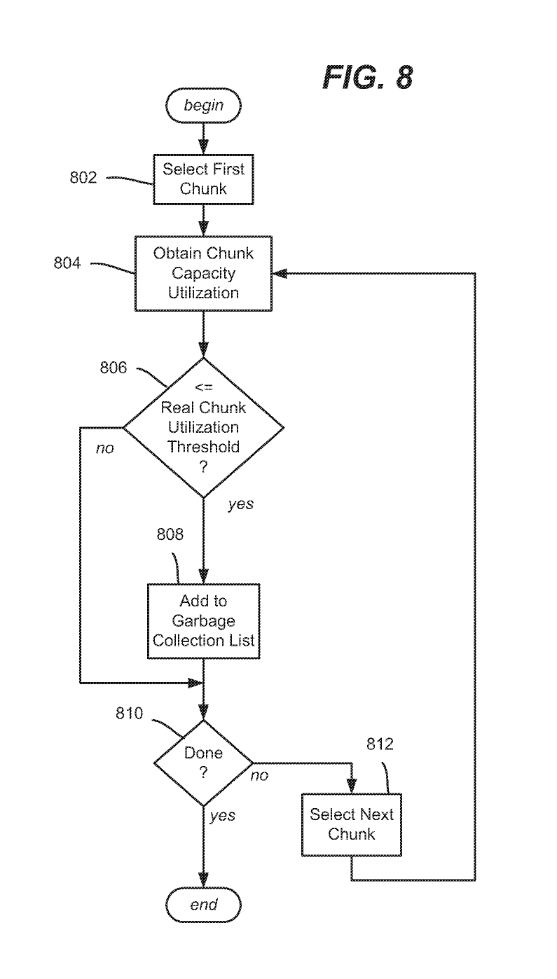

Turning to example operations, FIG. 8 is a flow diagram representing example logic/operations performed by the garbage collection-related components described herein. Note that some of the steps may be ordered differently, and or performed in parallel or substantially in parallel.

Operation 802 represents selecting a first chunk, e.g. from the chunk table. Operation 804 represents obtaining (e.g., computing) the chunk capacity utilization for the selected chunk. Operation 806 represents evaluating whether the selected chunk is considered as having low/lower capacity utilization, e.g., based on a threshold value, in which event that chunk is to be garbage collected, e.g. added to a garbage collection list at operation 808.

Operations 810 and 812 repeat the process for the next chunk and so on until some stopping criteria is reached. This may be when no chunks remain to be evaluated, may be time based, e.g., garbage collect scan for some amount of time, may be based on a number of chunks, may be based on some percentage of the node size and/or based on some other stopping criteria as is appropriate for a given data storage system and/or other factors (e.g., how busy the storage system is performing other tasks).

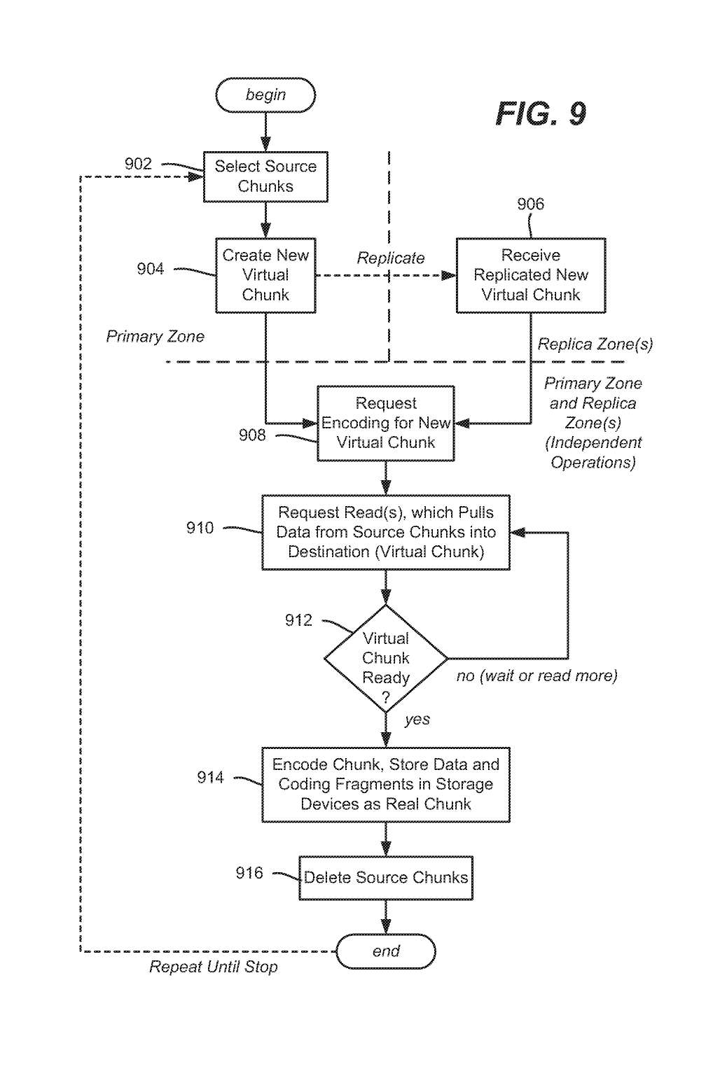

When at least part of the chunk data storage (e.g., chunk table) has been scanned and at least one chunk has been found to be considered lower capacity, copying garbage collection may begin as generally represented in the operations exemplified in FIG. 9. Copying garbage collection may be performed in many ways, and the operations in FIG. 9 are only examples of some of logic that may be performed.

Operation 902 selects low capacity chunks, e.g. from the list scanned in FIG. 8, which includes selecting segments from the (two or more) low-capacity chunks to be ultimately combined into a new, combined real chunk. Step 904 creates a new virtual chunk corresponding to the data segments to be combined; e.g., operation 904 also arranges the data layout for this new chunk. As described above, in ECS™ the creation of the virtual chunk in a primary zone automatically causes its replication to each other replica geographically distributed zone, with the replicated virtual chunk received at another zone(s) as represented by operation 906; (if not automatic, a “replication” operation following creation of the virtual chunk can be performed).

Operations 908 and beyond are independently performed in the primary zone and each other zone that receives a replica at operation 906. As generally described herein, operation 908 requests encoding of the new virtual chunk, which is related to operation 910 requesting data reads for that chunk, causing data to be pulled in from the source (low-capacity) chunks. In the primary (local) zone, these are the source chunks selected at operation 902, while in replica (remote) zone(s), these are the replicas of the source chunks, which as (data-wise identical) replicas are also low-capacity chunks.

Operation 912 waits for the virtual chunk to be ready, that is, for the reads to complete. Note that if the reads are requested at the same time, operation 912 waits for the slowest read operation to complete; if reads are made separately, operation 912 can return to operation 910 to request a next read, and so on. In any event, assuming no read errors or the like, the virtual chunk has the data from the sources read into it.

Operation 914 represents encoding the chunk, which stores its data and coding fragments in the storage devices as a “combined” chunk, that is, a new, real chunk having the data obtained from two or more source chunks. Operation 916 represents deleting the source chunks.

The example garbage collection process for one virtual chunk of FIG. 9 can be repeated as many times as needed, including via parallel operations within the same zone; (parallel operations in different zones are highly likely to occur, as such operations, following operation 908, inclusive, are independent in each zone). The process can end when all low-capacity chunks have been processed into combined chunks, however some other stopping criterion can halt or pause the garbage collection operations, such as when a time limit or other limit is reached, when resources allocated for garbage collection need to be reallocated to a higher priority task, and so on. The list of low usage capacity chunks not yet processed can be retained for use in a subsequent iteration, or discarded and regenerated in the next iteration.

As can be seen, described herein is an efficient technology for copying garbage collection that handles primary zone and replica zone garbage collection, in a way that reduces overall operations and data traffic. In existing ECS™ technologies, the copying garbage collection technology is practical and straightforward to implement, as existing mechanisms such as chunk management, replication, data migration concepts of pulling of data into virtual chunks, and so on can be leveraged to make automatic storage capacity management more efficient.

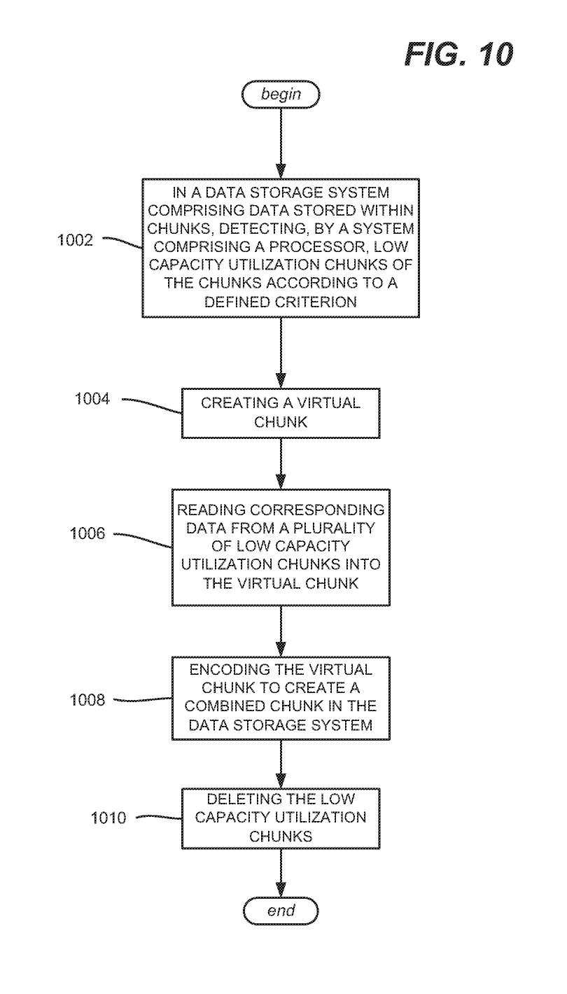

One or more aspects are represented as example operations in FIG. 10, and operate in a data storage system comprising data stored within chunks. Example operations comprise, detecting (operation 1002), by a system comprising a processor, low capacity utilization chunks of the chunks according to a defined criterion, and creating a virtual chunk (operation 1004). Operation 1006 comprises reading corresponding data from a plurality of low capacity utilization chunks into the virtual chunk, operation 1008 represents encoding the virtual chunk to create a combined chunk in the data storage system, and operation 1010 represents deleting the low capacity utilization chunks.

Creating the virtual chunk can comprise creating a data layout corresponding to system metadata without allocating physical capacity for the virtual chunk. Creating the virtual chunk can occur in a local zone of a geographically distributed environment, and example operations can comprise replicating the virtual chunk from the local zone to a remote zone of the geographically distributed environment as a replicated virtual chunk.

Reading the corresponding data from the low capacity utilization chunks to the virtual chunk to create the real new chunk in the data storage system can comprise requesting encoding of the real new chunk. Reading the corresponding data from a plurality of low capacity utilization chunks into the virtual chunk can comprise making read requests to the virtual chunk, redirecting each of the read requests to a corresponding one of the low capacity utilization chunks to obtain read data, and reading the read data into the virtual chunk. Encoding the virtual chunk can comprise storing the combined chunk as data fragments and coding fragments in one or more storage devices of the data storage system.

Creating the virtual chunk can occur in a local zone of a geographically distributed environment, and operations can comprise replicating the virtual chunk from the local zone to a remote zone of the geographically distributed environment as a replicated virtual chunk, and independently of the replicating, reading corresponding data from remote low capacity utilization replica chunks to the replicated virtual chunk to encode a replicated combined chunk in the remote zone the data storage system.

Detecting the low capacity utilization chunks can comprise evaluating chunks relative to a chunk capacity utilization threshold value representative of a threshold for chunk capacity utilization.

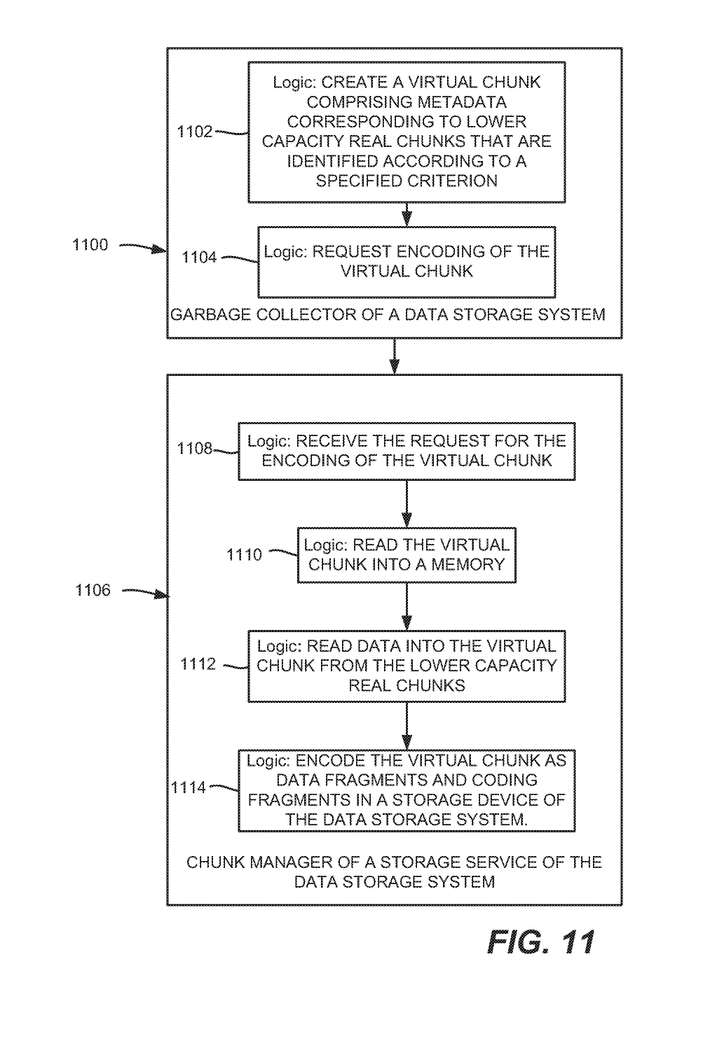

One or more aspects, generally exemplified in FIG. 11, can comprise a garbage collector (1100) of a data storage system. The garbage collector can be configured with logic to (1102) create a virtual chunk comprising metadata corresponding to lower capacity real chunks that are identified according to a specified criterion, and (1104) request encoding of the virtual chunk. A chunk manager 1106 of a storage service of the data storage system can be coupled to the garbage collector 1102, and can comprise logic configured to (1108) receive the request for the encoding of the virtual chunk, (1110) read the virtual chunk into a memory, (1112) read data into the virtual chunk from the lower capacity real chunks, and (1114) encode the virtual chunk as data fragments and coding fragments in a storage device of the data storage system.

The garbage collector can further detect the lower capacity real chunks. The garbage collector can further delete the lower capacity real chunks.

The chunk manager, to read the data into the virtual chunk, can make read requests based on the metadata, which redirects the read requests via a data migration service to pull data from the lower capacity real chunks into the virtual chunk.

The data storage system can comprise a local zone and a remote zone of a geographically distributed environment, the virtual chunk can be in a local zone of the data storage system, and the system can further comprise, a replication engine of the data storage system that replicates the virtual chunk to a replicated virtual chunk in the remote zone.

The system further can comprise a remote chunk manager of the remote zone that can receive a request for encoding of the replicated virtual chunk, read the replicated virtual chunk into a memory, read data into the replicated virtual chunk from remote replicas of the lower capacity real chunks, and encode the replicated virtual chunk as replicated data fragments and coding fragments in a remote replicated storage device of the data storage system.

The system further can comprise remote instance of the garbage collector configured to delete the remote zone replicas of the lower capacity real chunks.

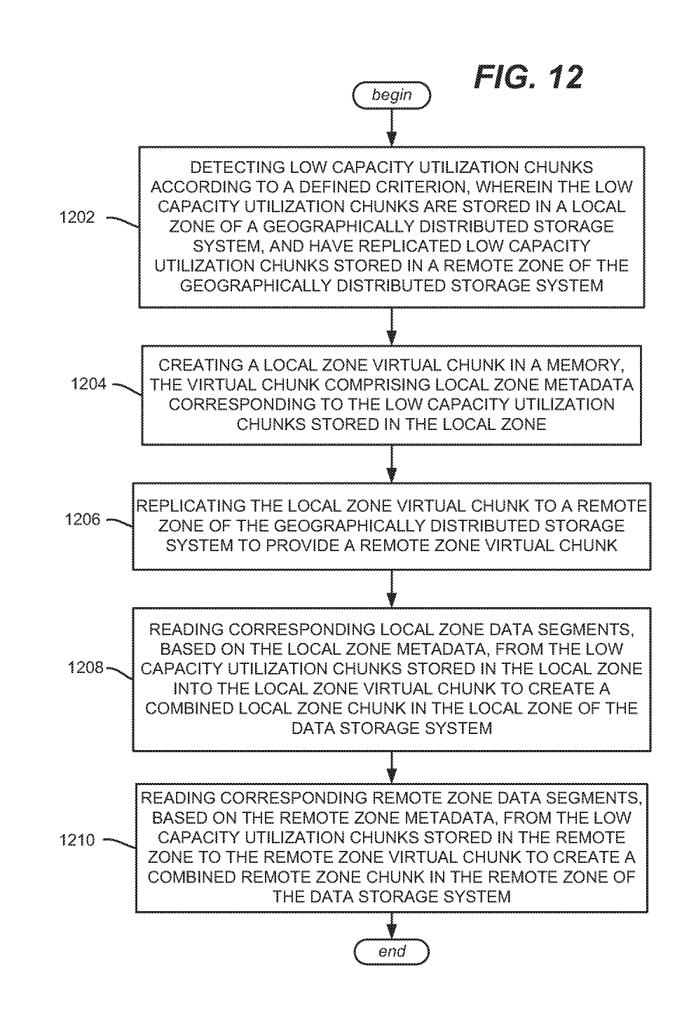

One or more aspects, such as implemented in a machine-readable storage medium, comprising executable instructions that, when executed by a processor, facilitate performance of operations, can be directed towards operations exemplified in FIG. 12. Example operation 1202 represents detecting low capacity utilization chunks according to a defined criterion, wherein the low capacity utilization chunks are stored in a local zone of a geographically distributed storage system, and have replicated low capacity utilization chunks stored in a remote zone of the geographically distributed storage system. Example operation 1204 represents creating a local zone virtual chunk in a memory, the virtual chunk comprising local zone metadata corresponding to the low capacity utilization chunks stored in the local zone. Example operation 1206 represents replicating the local zone virtual chunk to a remote zone of the geographically distributed storage system to provide a remote zone virtual chunk. Example operation 1208 represents reading corresponding local zone data segments, based on the local zone metadata, from the low capacity utilization chunks stored in the local zone into the local zone virtual chunk to create a combined local zone chunk in the local zone of the data storage system. Example operation 1210 represents reading corresponding remote zone data segments, based on the remote zone metadata, from the low capacity utilization chunks stored in the remote zone to the remote zone virtual chunk to create a combined remote zone chunk in the remote zone of the data storage system.

Reading the corresponding local zone data segments and reading the corresponding remote zone data segments can occur in parallel or substantially in parallel.

Other operations can comprise, reclaiming data storage capacity in the data storage system, which can comprise deleting the local zone low capacity utilization chunks and deleting the replicated remote zone low capacity utilization chunks.

Reading the corresponding local zone data segments from the local zone low capacity utilization chunks to the local zone virtual chunk to create the combined local zone chunk in the local zone can comprise requesting encoding of the real new chunk in the local zone, and wherein the copying the corresponding remote zone data segments from the remote zone low capacity utilization chunks to the remote zone virtual chunk to create the real new chunk in the remote zone comprises requesting encoding of the real new chunk in the remote zone.

Other operations can comprise encoding the local zone combined chunk, which can comprise storing the local zone combined chunk as local zone data fragments and local zone coding fragments in one or more local zone storage devices of the data storage system, and encoding the remote zone combined chunk, which can comprise storing the remote zone combined chunk as remote zone data fragments and remote zone coding fragments in one or more remote zone storage devices of the data storage system.

### Example Computing Device

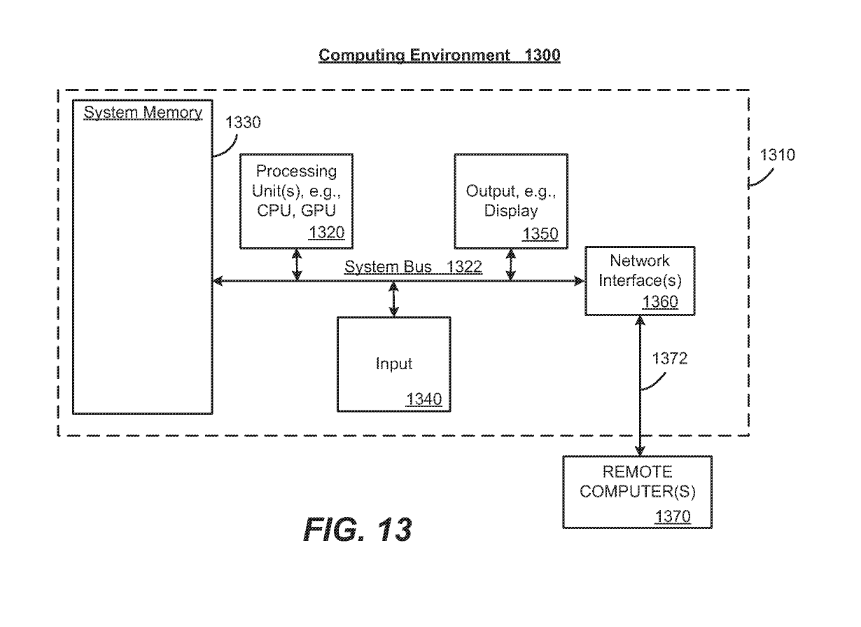

The techniques described herein can be applied to any device or set of devices (machines) capable of running programs and processes. It can be understood, therefore, that servers including physical and/or virtual machines, personal computers, laptops, handheld, portable and other computing devices and computing objects of all kinds including cell phones, tablet/slate computers, gaming/entertainment consoles and the like are contemplated for use in connection with various implementations including those exemplified herein. Accordingly, the general purpose computing mechanism described below with reference to FIG. 13 is but one example of a computing device.

Implementations can partly be implemented via an operating system, for use by a developer of services for a device or object, and/or included within application software that operates to perform one or more functional aspects of the various implementations described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 13 thus illustrates an example of a suitable computing system environment 1300 in which one or aspects of the implementations described herein can be implemented, although as made clear above, the computing system environment 1300 is only one example of a suitable computing environment and is not intended to suggest any limitation as to scope of use or functionality. In addition, the computing system environment 1300 is not intended to be interpreted as having any dependency relating to any one or combination of components illustrated in the example computing system environment 1300.

With reference to FIG. 13, an example device for implementing one or more implementations includes a general purpose computing device in the form of a computer 1310. Components of computer 1310 may include, but are not limited to, a processing unit 1320, a system memory 1330, and a system bus 1322 that couples various system components including the system memory to the processing unit 1320.

Computer 1310 typically includes a variety of machine (e.g., computer) readable media and can be any available media that can be accessed by a machine such as the computer 1310. The system memory 1330 may include computer storage media in the form of volatile and/or nonvolatile memory such as read only memory (ROM) and/or random access memory (RAM), and hard drive media, optical storage media, flash media, and so forth. By way of example, and not limitation, system memory 1330 may also include an operating system, application programs, other program modules, and program data.

A user can enter commands and information into the computer 1310 through one or more input devices 1340. A monitor or other type of display device is also connected to the system bus 1322 via an interface, such as output interface 1350. In addition to a monitor, computers can also include other peripheral output devices such as speakers and a printer, which may be connected through output interface 1350.

The computer 1310 may operate in a networked or distributed environment using logical connections to one or more other remote computers, such as remote computer 1370. The remote computer 1370 may be a personal computer, a server, a router, a network PC, a peer device or other common network node, or any other remote media consumption or transmission device, and may include any or all of the elements described above relative to the computer 1310. The logical connections depicted in FIG. 13 include a network 1372, such as a local area network (LAN) or a wide area network (WAN), but may also include other networks/buses. Such networking environments are commonplace in homes, offices, enterprise-wide computer networks, intranets and the internet.

As mentioned above, while example implementations have been described in connection with various computing devices and network architectures, the underlying concepts may be applied to any network system and any computing device or system in which it is desirable to implement such technology.

Also, there are multiple ways to implement the same or similar functionality, e.g., an appropriate API, tool kit, driver code, operating system, control, standalone or downloadable software object, etc., which enables applications and services to take advantage of the techniques provided herein. Thus, implementations herein are contemplated from the standpoint of an API (or other software object), as well as from a software or hardware object that implements one or more implementations as described herein. Thus, various implementations described herein can have aspects that are wholly in hardware, partly in hardware and partly in software, as well as wholly in software.

The word “example” is used herein to mean serving as an example, instance, or illustration. For the avoidance of doubt, the subject matter disclosed herein is not limited by such examples. In addition, any aspect or design described herein as “example” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts/flow diagrams of the various figures. While for purposes of simplicity of explanation, the methodologies are shown and described as a series of blocks, it is to be understood and appreciated that the various implementations are not limited by the order of the blocks, as some blocks may occur in different orders and/or concurrently with other blocks from what is depicted and described herein. Where non-sequential, or branched, flow is illustrated via flowcharts/flow diagrams, it can be appreciated that various other branches, flow paths, and orders of the blocks, may be implemented which achieve the same or a similar result. Moreover, some illustrated blocks are optional in implementing the methodologies described herein.

### Conclusion

While the invention is susceptible to various modifications and alternative constructions, certain illustrated implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the invention is not to be limited to any single implementation, but rather is to be construed in breadth, spirit and scope in accordance with the appended claims.

What is claimed is:

1. A method, comprising:
in a data storage system comprising data stored within chunks, detecting, by a system comprising a processor, low capacity utilization chunks of the chunks according to a defined criterion;
creating a virtual chunk;
reading corresponding data from low capacity utilization chunks into the virtual chunk;
encoding the virtual chunk to create a combined chunk in the data storage system; and
deleting the low capacity utilization chunks.

2. The method of claim 1, wherein the creating the virtual chunk comprises creating a data layout corresponding to system metadata without allocating physical capacity for the virtual chunk.

3. The method of claim 1, wherein the creating the virtual chunk occurs in a local zone of a geographically distributed environment, and the method further comprises, replicating the virtual chunk from the local zone to a remote zone of the geographically distributed environment as a replicated virtual chunk.

4. The method of claim 1, wherein the reading the corresponding data from the low capacity utilization chunks to the virtual chunk to create the real new chunk in the data storage system comprises requesting encoding of the real new chunk.

5. The method of claim 1, wherein the reading the corresponding data from the low capacity utilization chunks into the virtual chunk comprises making read requests to the virtual chunk, redirecting each of the read requests to a corresponding one of the low capacity utilization chunks to obtain read data, and reading the read data into the virtual chunk.

6. The method of claim 1, wherein the encoding the virtual chunk comprises storing the combined chunk as data fragments and coding fragments in one or more storage devices of the data storage system.

7. The method of claim 1, wherein the creating the virtual chunk occurs in a local zone of a geographically distributed environment, and the method further comprises, replicating the virtual chunk from the local zone to a remote zone of the geographically distributed environment as a replicated virtual chunk, and independently of the replicating, reading corresponding data from remote low capacity utilization replica chunks to the replicated virtual chunk to encode a replicated combined chunk in the remote zone of the data storage system.

8. The method of claim 1, wherein the detecting the low capacity utilization chunks comprises evaluating chunks relative to a chunk capacity utilization threshold value representative of a threshold for chunk capacity utilization.

9. A system, comprising:
a garbage collector of a data storage system, the garbage collector being configured to:
create a virtual chunk comprising metadata corresponding to lower capacity real chunks that are identified according to a specified criterion, and
request encoding of the virtual chunk; and
a chunk manager of a storage service of the data storage system, the chunk manager coupled to the garbage collector, and the chunk manager being configured to:
receive the request for the encoding of the virtual chunk, read the virtual chunk into a memory;
read data into the virtual chunk from the lower capacity real chunks, and
encode the virtual chunk as data fragments and coding fragments in a storage device of the data storage system.

10. The system of claim 9, wherein the garbage collector is further configured to detect the lower capacity real chunks.

11. The system of claim 9, wherein the chunk manager, to read the data into the virtual chunk, is further configured to make read requests based on the metadata, which redirects the read requests via a data migration service to pull data from the lower capacity real chunks into the virtual chunk.

12. The system of claim 9, wherein the garbage collector is further configured to delete at least one of the lower capacity real chunks.

13. The system of claim 9, wherein the data storage system comprises a local zone and a remote zone of a geographically distributed environment, wherein the virtual chunk is in a local zone of the data storage system, and wherein the system further comprises a replication engine of the data storage system that replicates the virtual chunk to a replicated virtual chunk in the remote zone.

14. The system of claim 13, further comprising a remote chunk manager of the remote zone, the remote chunk manager being configured to receive a request to encode the replicated virtual chunk, read the replicated virtual chunk into a memory, read data into the replicated virtual chunk from remote replicas of the lower capacity real chunks, and encode the replicated virtual chunk as replicated data fragments and coding fragments in a remote replicated storage device of the data storage system.

15. The system of claim 13, further comprising a remote instance of the garbage collector configured to delete the remote zone replicas of the lower capacity real chunks.

16. A machine-readable storage medium, comprising executable instructions that, when executed by a processor, facilitate performance of operations, the operations comprising:
detecting low capacity utilization chunks according to a defined criterion, wherein the low capacity utilization chunks are stored in a local zone of a geographically distributed storage system, and have replicated low capacity utilization chunks stored in a remote zone of the geographically distributed storage system;
creating a local zone virtual chunk in a memory, the local zone virtual chunk comprising local zone metadata corresponding to the low capacity utilization chunks stored in the local zone;
replicating the local zone virtual chunk to a remote zone of the geographically distributed storage system to provide a remote zone virtual chunk;
reading corresponding local zone data segments, based on the local zone metadata, from the low capacity utilization chunks stored in the local zone into the local zone virtual chunk to create a combined local zone chunk in the local zone of the data storage system; and
reading corresponding remote zone data segments, based on the remote zone metadata, from the low capacity utilization chunks stored in the remote zone to the remote zone virtual chunk to create a combined remote zone chunk in the remote zone of the data storage system.

17. The machine-readable storage medium of claim 16, wherein the reading the corresponding local zone data segments and the reading the corresponding remote zone data segments occur in parallel or substantially in parallel.

18. The machine-readable storage medium of claim 16, wherein the operations further comprise, reclaiming data storage capacity in the data storage system, comprising deleting at least some of the local zone low capacity utilization chunks and deleting at least some of the replicated remote zone low capacity utilization chunks.

19. The machine-readable storage medium of claim 16, wherein the reading the corresponding local zone data segments from the local zone low capacity utilization chunks to the local zone virtual chunk to create the combined local zone chunk in the local zone comprises requesting encoding of the real new chunk in the local zone, and wherein the copying the corresponding remote zone data segments from the remote zone low capacity utilization chunks to the remote zone virtual chunk to create the real new chunk in the remote zone comprises requesting encoding of the real new chunk in the remote zone.

20. The machine-readable storage medium of claim 19, wherein the operations further comprise, encoding the local zone combined chunk, comprising storing the local zone combined chunk as local zone data fragments and local zone coding fragments in one or more local zone storage devices of the data storage system, and encoding the remote zone combined chunk, comprising storing the remote zone combined chunk as remote zone data fragments and remote zone coding fragments in one or more remote zone storage devices of the data storage system.
